(19) United States
(12) Patent Application Publication
(10) Pub. No.: US 2007/0240639 A1
(43) Pub. Date: Oct. 18, 2007

(54) Injector with a coating head

(75) Inventors: Frank Wang, Taipei (TW); Yi-Lun Cheng, Taipei (TW); Jui-Chan Fan, Taipei (TW); Chun-Yi Chang, Taipei (TW); Chun-Lung Lin, Taipei (TW); Chih-Kai Yang, Taipei (TW)

Correspondence Address: HARNESS, DICKEY & PIERCE, P.L.C., P.O. BOX 8910, RESTON, VA, 20195, US

(73) Assignee: Inventec Corporation

(21) Appl. No.: 11/405,640

(22) Filed: Apr. 18, 2006

(51) Int. Cl. B05C 3/02; B05C 1/00

(52) U.S. Cl. 118/211; 118/213; 118/410

(57) ABSTRACT

An injector with a coating head, for uniformly coating a heat sink paste onto a surface to be coated is provided, which includes a body, a piston, and a coating head, wherein the piston is pressed to force the heat sink paste out of the body through the coating head, and the heat sink paste is molded by the coating head into a shape suitable for uniformly coating the surface to be coated, and is also quantified. Moreover, a scraping surface is provided at the opening of the coating head, for scraping off the redundant heat sink paste from the steel plate and for smoothing the surface of the heat sink paste, in the case that a steel plate is used to assist the quantifying operation of the heat sink paste.

### BACKGROUND OF THE INVENTION

1. Field of Invention

The present invention relates to an injector, and more particularly, to an injector with a coating head for uniformly coating a heat sink paste onto a surface to be coated.

2. Related Art

The computer processor generates high heat when operating, thus a heat sink is required to be installed on the electronic element for heat dissipation. However, if there is a gap between the electronic element and the heat sink due to a poor fit, heat conduction will be significantly influenced, and thus the function of the heat sink cannot be achieved thoroughly. Therefore, a heat sink paste is used to fill the gap between the electronic element and the bottom of the heat sink, such that the heat can be successfully transferred to the heat sink. When the heat sink paste is directly coated onto the surface to be coated, as the heat sink paste is packaged in a syringe form, the heat sink paste extruded from the needle is in a spherical form, and it is uneasy to be spread onto the surface to be coated, and it is difficult for the pressed quantity to be controlled, resulting in a waste of heat sink paste. Furthermore, a steel plate printing method can be used to coat the heat sink paste: covering the screen printing area of the steel plate on the surface to be coated; injecting the heat sink paste into the screen printing area; and then removing the steel plate. However, the steel plate printing process is carried out in combination with an automatic dispensing system, and with a mechanical control, the heat sink paste extruded from the heat sink paste injector cannot be uniformly coated in the screen printing area, and a manual action is often required to make up the filling, or scrape off redundant heat sink paste from the steel plate. Also, considering the manufacturing cost of the steel plate, it cannot be provided for ordinary family use.

In summary, in both manual manner and mechanical manner, the problem that the heat sink paste cannot be uniformly coated occurs. To solve such a problem, a heat sink paste coater is disclosed in U.S. Pat. No. 6,881,265 published on Apr. 19, 2005, which consists of a basal portion, a capping portion, and a pushing portion, wherein forming a cavity by combining the basal portion and the capping portion; pushing the pushing portion into an upper part of the cavity; fully filling a lower part of the cavity with the heat sink paste; covering the bottom of the coater on the surface to be coated; applying a pressing force downwards onto the capping portion and pulling out the pushing portion, such that the heat sink paste at the bottom of the cavity is adhered onto the surface to be coated; and finally, removing the coater upwards. As the sectional area and the thickness of the lower cavity are fixed, the quantity and shape of the heat sink paste can be controlled by the volume of the lower part of the cavity, and a uniformly coated effect can be achieved. However, the coater requires an extra action for making up for the filling of the heat sink paste, and it is inconvenient to be operated and unsuitable for mechanical operation.

### SUMMARY OF THE INVENTION

The present invention discloses an injection with a coating head for uniformly coating the heat sink paste onto the surface to be coated. A steel plate is selectively covered around the surface to be coated to assist the quantification of the heat sink paste. This injector includes a body, a piston, and a coating head, wherein: the body has a depot and an outlet, the depot being used to accommodate the heat sink paste; the piston is used to plug through the depot, such that a relative displacement is generated between the piston and the depot to extrude the heat sink paste out through the outlet; and, the coating head has a joint end and a discharge end, wherein the joint end is installed on the body for communicating with the outlet, and the discharge end receives the heat sink paste from the joint end and then send the heat sink paste to the surface to be coated, with an inner diameter being equal to the length of one side of the surface to be coated. Furthermore, the coating head of the present invention can be integrated with the body, directly communicating with the depot and sending out the heat sink paste for coating the surface to be coated. The heat sink paste sent out by the coating head is provided with a shape suitable for uniformly coating the surface to be coated through the molding of the coating head. Also, a quantification of the heat sink paste can be provided without the steel plate. Moreover, a scraping surface is provided at the opening of the coating head, such that redundant heat sink paste can be directly scraped off and the heat sink paste surface can be directly smoothed when using the steel plate. The technical means used by the present invention to solve the conventional technical problems can be understood from the embodiments of the present invention.

In summary, through the technical means of the present invention, the conventional technical problems can be solved efficiently, including the problem for uniformly coating the surface to be coated with the heat sink paste, quantifying the heat sink paste and directly scraping off the redundant heat sink paste on the steel plate, and therefore, the present invention is full of industrial applicability, novelty, and inventiveness.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is an assembly view of the present invention;

FIG. 2 is a schematic view of a first embodiment of the present invention;

FIGS. 3A and 3B are schematic views illustrating the implementation of the first embodiment of the present invention;

FIG. 4 is a schematic view of a second embodiment of the present invention;

FIGS. 5A and 5B are schematic views illustrating the implementation of the second embodiment of the present invention;

FIG. 6 is a schematic view of a third embodiment of the present invention;

FIGS. 7A and 7B are schematic views illustrating the implementation of the third embodiment of the present invention;

FIG. 8 is a schematic view of a fourth embodiment of the present invention; and

FIGS. 9A, 9B and 9C are schematic views illustrating the implementation of the fourth embodiment of the present invention.

### DETAILED DESCRIPTION OF THE INVENTION

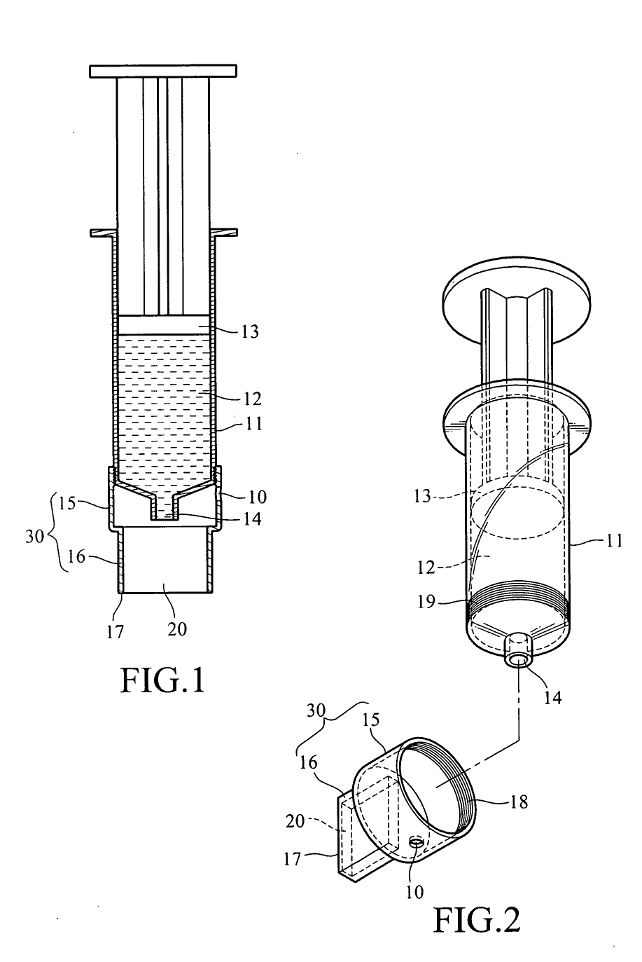

Referring to FIG. 1, it is an assembly view of the present invention. An injector with a coating head is disclosed, which structurally includes a body 11, a piston 13, and a coating head 30, wherein the body 11 has a depot 12 and an outlet 14; the coating head 30 has a joint end 15 and a discharge end 16, and the coating head 30 also has a vent hole 10. The depot 12 is used to accommodate the heat sink paste, and the piston 13 is used to plug through the depot 12, wherein a pressing force is applied in a manual or mechanical manner, such that a relative displacement is generated between the piston 13 and the depot 12 to extrude the heat sink paste out through the outlet 14. The joint end 15 is installed on the body 11 for communicating with the outlet 14, and the discharge end 16 receives the heat sink paste from the joint end 15 and sends the heat sink paste out. The present invention is used to uniformly coat the heat sink paste onto the surface to be coated of the heat sink or the heat sink surface of the electronic element, and the steel plate can be selectively covered around the surface to be coated, so as to assist the quantification of the heat sink paste.

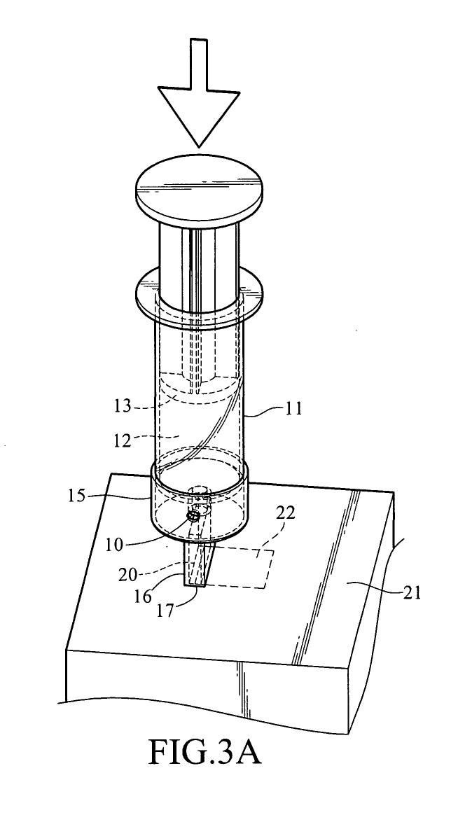

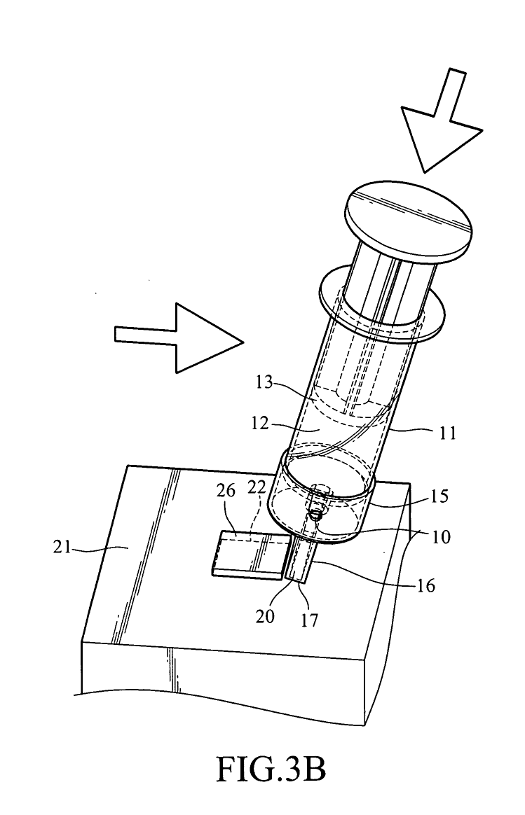

Referring to FIG. 2, it shows a first embodiment of the present invention. As shown, the body 11 has an inside screw thread 19, and an outside screw thread 18 is provided in the interior of the joint end 15. Furthermore, an opening 20 and a scraping surface 17 are provided at the bottom of the discharge end 16. The outside screw thread 18 and the inside screw thread 19 are locked to each other, so as to install the coating head 30 on the body 11. Then, referring to FIGS. 3A and 3B, they illustrate the implementation of the first embodiment. There is a surface 22 to be coated with a heat sink paste on an electronic element surface 21 (also a heat sink surface). As shown, the body 11 is held by the operator with the opening 20 aligned with one side of the surface to be coated 22, and then the scraping surface 17 is pressed against the electronic element surface 21 for pre-injecting. Then, a pressing force is applied to the piston 13 by the hand, such that the heat sink paste within the depot 12 is extruded downwards to fill the joint end 15 and the discharge end 16, wherein a vent hole 10 is located at the joint end 15, such that the air in the discharge end 16 can be discharged through the vent hole 10, and the discharge end 16 can be filled up with the heat sink paste accordingly. At that time, the heat sink paste in the discharge end 16 is molded into a fixed volume, and when the heat sink paste spills out of the vent hole 10, it indicates that the pre-injecting has completed (as shown in FIG. 3A). Then, the body 11 is inclined, such that the scraping surface 17 is non-contacted with the electronic element surface 21, and the body 11 is dragged along the other side of the surface to be coated 22 while a pressing force is applied to the piston 13. Thus, the molded heat sink paste within the discharge end 16 is sent out through the opening 20, and uniformly coated on the surface to be coated 22 to form a heat sink paste layer 26 (as shown in FIG. 3B). After the coating is finished, the discharge end 16 can be removed upwards. The inner diameter of the opening 20 is equal to the length of one side of the coated area 22, such that the heat sink paste layer 26 has a fixed volume due to the molding process of the discharge end 16 and the controlling of the dragging length; thus, an effect of uniformly coating and quantifying the heat sink paste can be achieved. In the present invention, although the heat sink paste layer 26 is molded by the cuboid of the discharge end 16, the form of the heat sink paste sent out of the opening 20 also can be fixed, and an object for molding the heat sink paste layer 26 also can be achieved, so long as the area of the opening 20 fits the requirements of the surface to be coated 22, and the heat sink paste filling into the discharge end 16 during the pre-injecting process is sufficient for coating the surface to be coated 22, which falls into the scope to be protected of the present invention.

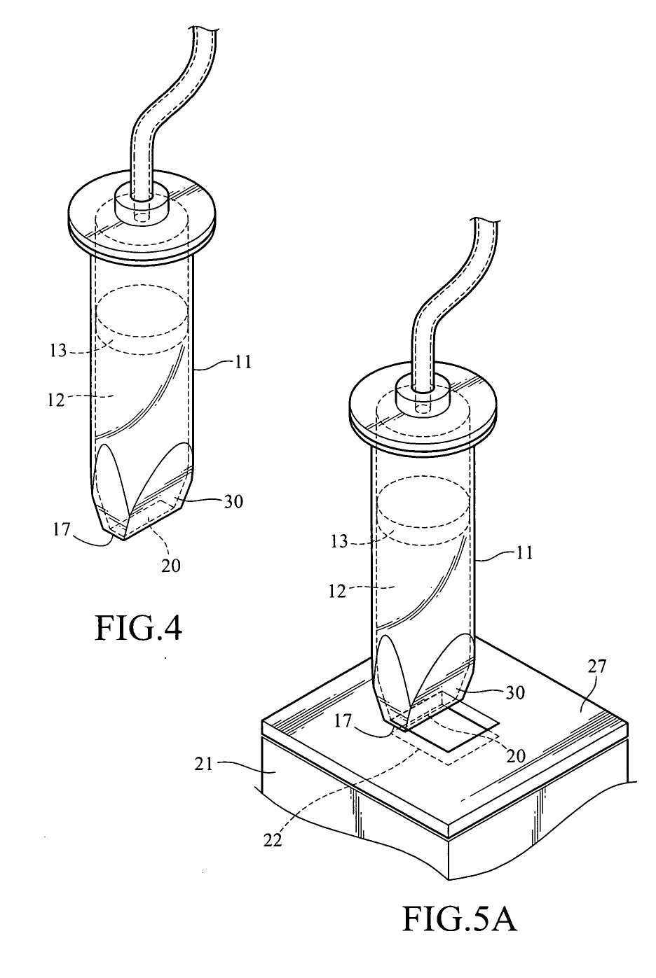

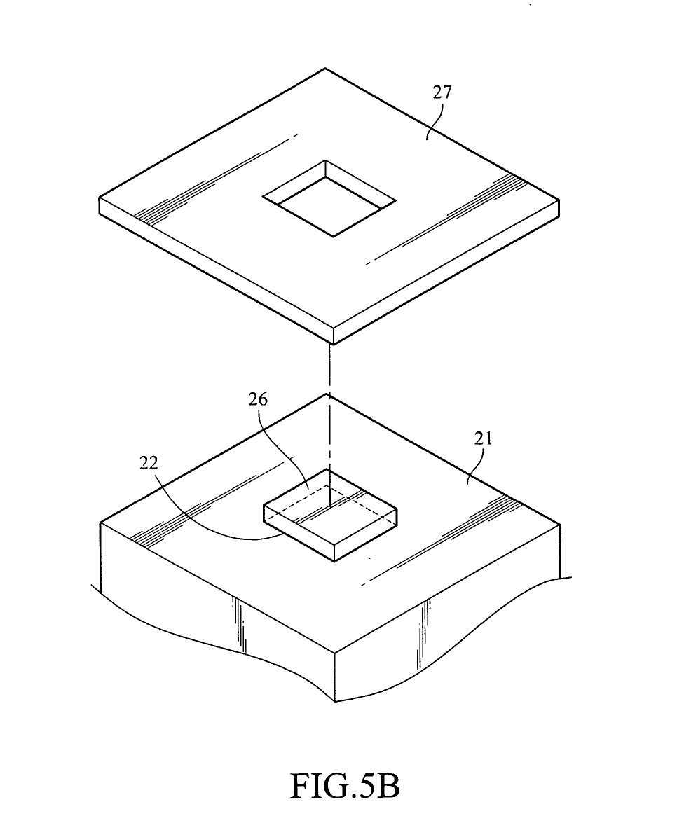

Referring to FIG. 4, it shows a second embodiment of the present invention. As shown, the coating head 30 is integrated with the body 11, and the opening 20 and the scraping surface 17 are provided at the bottom of the coating head 30, and the coating head 30 is directly communicated with the depot 12 and the heat sink paste is sent out via the opening 20, wherein the piston 13 is pushed by a mechanically-controlled pneumatic system (not shown). In the second embodiment, the coating is carried out with an aid of the steel plate. Referring to FIGS. 5A and 5B, they illustrate the implementation of the second embodiment. The steel plate 27 is covered around the surface to be coated 22 of the electronic element surface 21. The body 11 is held by the operator, with the opening 20 being aligned with and above one side of the surface to be coated 22, and the part of the scraping surface 17 which may contact the steel plate 27 being pressed against the surface of the steel plate 27 (as shown in FIG. 5A). The pneumatic system is started, such that the piston 13 is pressed downwards to extrude the heat sink paste onto the surface to be coated 22, and at the same time, the body 11 is dragged along the other side of the surface to be coated 22, such that the heat sink paste sent out of the opening 20 is coated onto the surface to be coated 22, and the heat sink paste is limited within the screen printing area surrounded by the steel plate 27, and also the heat sink paste spilled over the steel plate can be scraped off and the heat sink paste surface can be smoothed by the scraping surface 17. If the heat sink paste sent out of the opening 20 is insufficient for filling up the screen printing area of the steel plate 27 on the surface to be coated 22 with one injecting action, a back-and-forth coating can be carried out. The inner diameter of the opening 20 is equal to the length of one side of the coated area 22, such that the heat sink paste sent out during dragging can be uniformly spread, the surface of the heat sink paste sent out can be smoothed by the scraping surface. Thus, the heat sink paste can be uniformly filled into the screen printing area of the steel plate 27 without further refilling or scraping the redundant heat sink paste on the steel plate with a scraper. After the coating is finished, the steel plate 27 is removed upwards, such that a heat sink paste layer 26 with a fixed volume is formed on the surface to be coated 22 (as show in FIG. 5B). The coating head 30 of the second embodiment also can be connected with the body 11 in a manner of extra installment as that of the first embodiment, and as for the steel plate 27 used to assist the coating, the aforementioned pre-injecting is not required any more, thus the vent hole 10 is also not required (referring to FIG. 1).

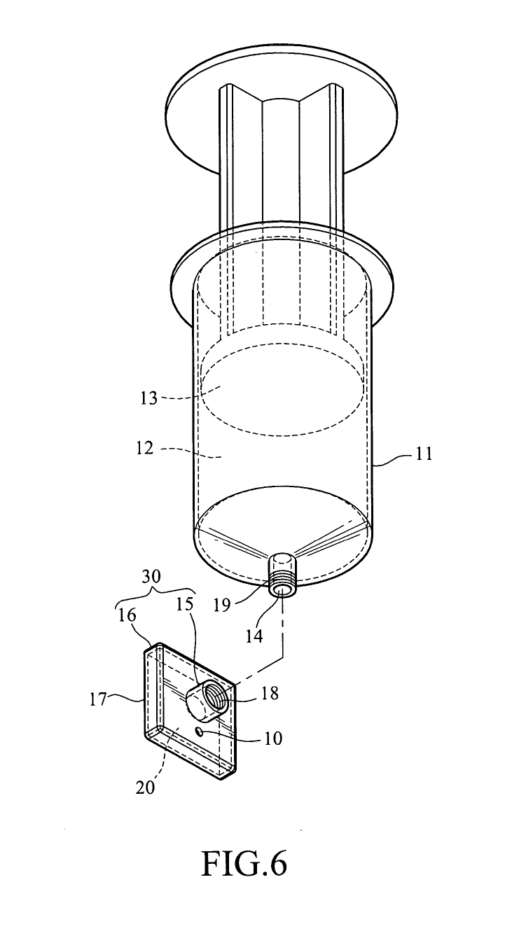

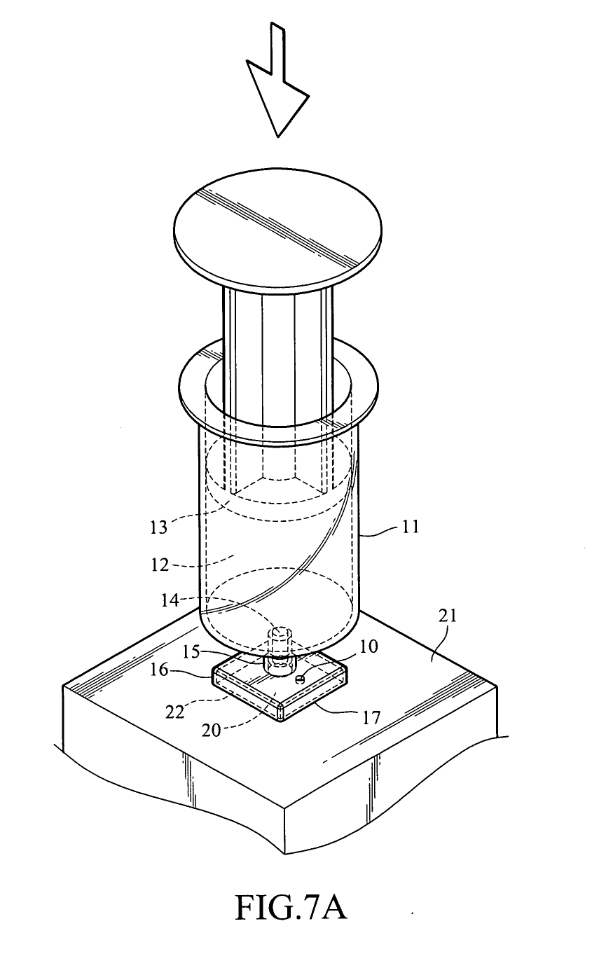

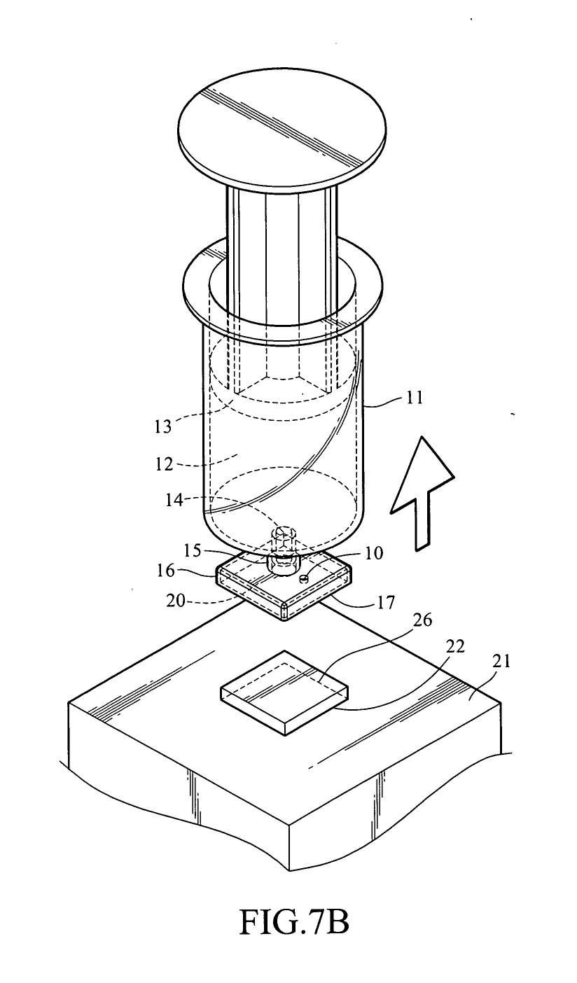

Furthermore, the coating can be carried out without a dragging action in the present invention. Referring to FIG. 6, it shows a third embodiment of the present invention. In this embodiment, an inside screw thread 19 is provided near the upper edge of the opening 14 on the body 11, and an outside screw thread 18 is provided inside the joint end 15. Furthermore, an opening 20 and a scraping surface 17 are provided at the bottom of the discharge end 16. The outside screw thread 18 and the inside screw thread 19 is locked to each other, so as to install the coating head 30 onto the body 11. A vent hole 10 is formed on a face of the discharge end 16 near the joint end 15. Then, referring to FIGS. 7A and 7B, they illustrate the implementation of the third embodiment. There is a surface to be coated 22 on the electronic element surface 21. As shown, the body 11 is held by the operator, with the opening 20 aligned with the surface to be coated 22, wherein the area of opening 20 is equal to the area of the surface to be coated 22. After the positioning alignment, the scraping surface 17 is pressed against the electronic element surface 21, a pressing force is applied to the piston 13 to extrude the heat sink paste within the depot 12 downwards, such that the heat sink paste is filled into the joint end 15 and the discharge end 16, wherein the vent hole 10 can be used to discharge the air inside the discharge end 16 and enable the discharge end 16 to be filled up with the heat sink paste. At that time, the heat sink paste within the discharge end 16 is molded into a fixed volume. When-the heat sink paste spills out through the vent hole 10, it indicates that the filling has been finished (as shown in FIG. 7A). Then, the discharge end 16 is removed upwards, such that the surface to be coated 22 is uniformly coated with a heat sink paste layer 26 (as shown in FIG. 7B). In such a way, through the molding with the discharge end 16, an effect of quantifying and uniformly shaping the heat sink paste layer 26 can be achieved, and the dragging action can be omitted.

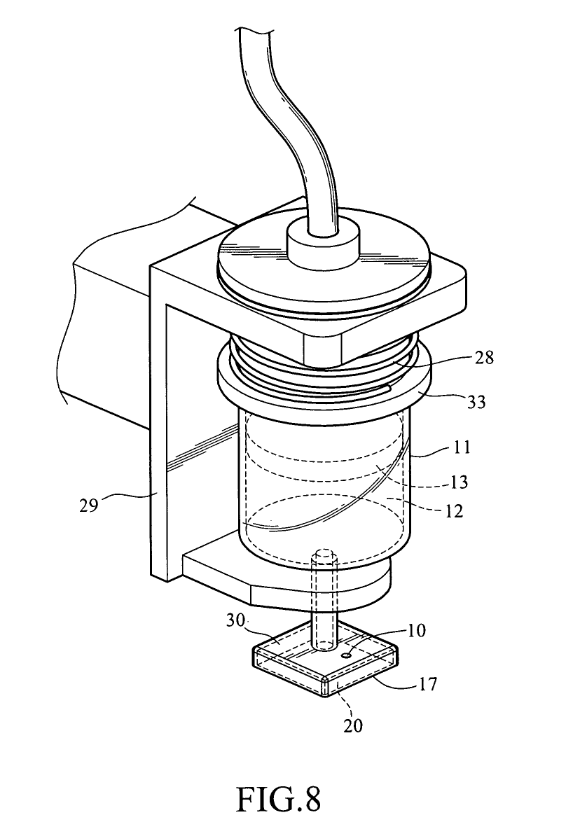

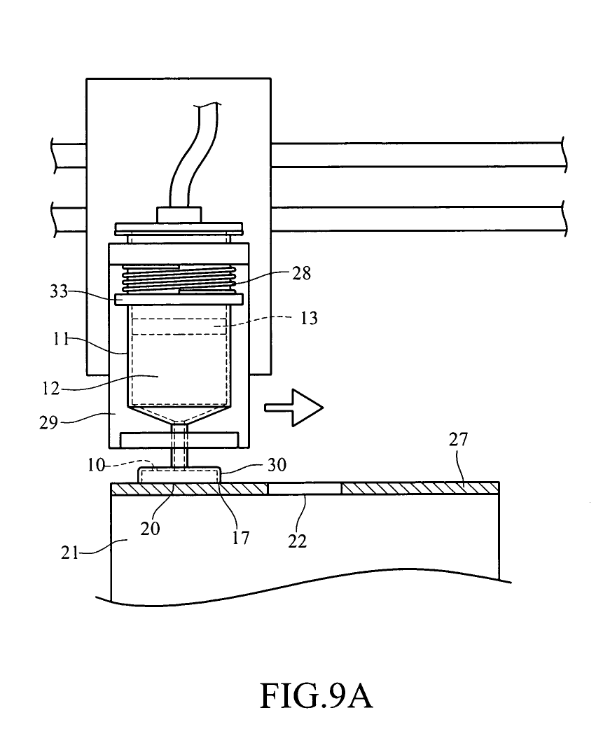

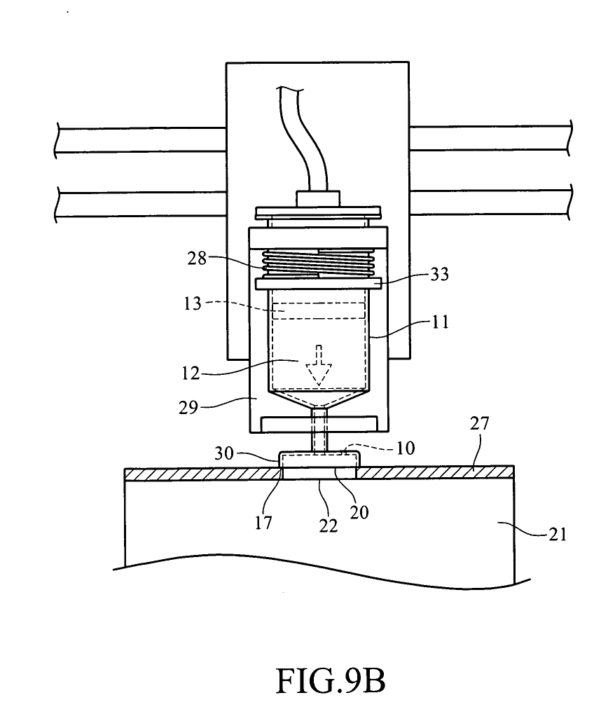

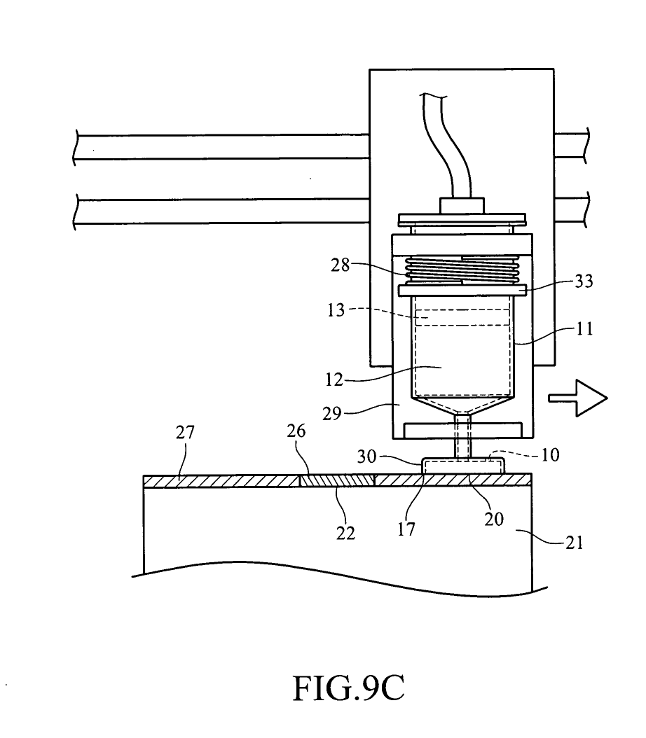

Referring to FIG. 8, it shows a fourth embodiment of the present invention. As shown, the coating head 30 is integrated with the body 11, and the coating head 30 has an opening 20, a scraping surface 17, and a vent hole 10. The coating head 30 communicates directly with the depot 12 and the heat sink paste is sent out through the opening 20. The body 11 has a protruding portion 33, and a spring 28 surrounding the body 11 and pressing against the protruding portion 33, wherein the piston 13 is pushed by a mechanically-controlled pneumatic system (not shown). The coating with a robot arm 29 can be carried out with an aid of the steel plate in the fourth embodiment. Referring to FIGS. 9A, 9B, and 9C, they illustrate the implementation of the fourth embodiment. A steel plate 27 is covered around the surface to be coated 22 of the electronic element surface 21, and the robot arm 29 clamps the body 11 and presses the spring 28 together with the protruding portion 33. When the robot arm 29 presses downwards, the spring 28 receives a downward force from the robot arm 29 to apply a pressing force to the body 11, such that the coating head 30 contacts with the steel plate 27, and thereby the scraping surface 17 is pressed against the surface of the steel plate 27 due to the pressing force applied by the spring 28, and also, the opening 20 is aligned with the screen printing area surrounded by the steel plate 27 on the surface to be coated 22 (as shown in FIG. 9A). Then, a pre-injecting process is carried out, wherein the pneumatic system is started, such that the piston 13 is pushed downwards to extrude the heat sink paste within the depot 12, and thus the heat sink paste is filled within the coating head 30, and the vent hole 10 can be used to discharge the air within the coating head 30, so as to fill up the coating head 30 with the heat sink paste. At that time, the heat sink paste within the coating head 30 can be formed into a fixed volume. When the heat sink paste spills out of the vent hole 10, it indicates that the pre-injecting has been finished. Then, the robot arm 29 is moved, or the electronic element surface 21 and the steel plate 27 thereon are moved by a conveying belt (not shown), such that a relative displacement occurs between the body 11 and the surface to be coated 22, and the scraping surface 17 is pressed against the surface of the steel plate 27 due to the downward force from the spring 28 during the displacement. When the opening 20 is completely overlapped on the surface to be coated 22, the heat sink paste pre-filled within the coating head 30 will fall into the screen printing area of the steel plate 27 to be coated onto the surface to be coated 22. At the same time, the piston 13 can continuously extrude the heat sink paste within the depot 12 to fill the gap of the coating head 30 and facilitate the heat sink paste to be fully coated onto the surface to be coated 22 (as shown in FIG. 9B). After the screen printing area of the steel plate 27 is filled up, a relative displacement occurs between the body 11 and the surface to be coated 22, such that the coating head 30 is removed from the coated area 22. As the scraping surface 17 is pressed against the surface of the steel plate 27 due to the downward force of the spring 28 during the displacement, such that the redundant heat sink paste on the steel plate can be scraped off and the heat sink paste surface passed by the scraping surface 17 can be smoothed by the scraping surface 17 (as shown in FIG. 9C). After the coating is finished, the body 11 is removed from the steel plate 27, as descried in the previous embodiments, such that a heat sink paste layer 26 is uniformly coated on the surface to be coated 22 (referring to FIG. 5B). The coating head 30 of this embodiment can be used to limit the heat sink paste within the screen printing area, preventing too much heat sink paste from remaining on the steel plate 27; thus, achieving an uniformly-coating effect of the heat sink paste. Besides, in this embodiment, no pre-injecting action is required for the coating head 30, wherein the opening 20 can be overlapped above the surface to be coated 22 by directly controlling the robot arm 29, the scraping surface 17 is pressed against the surface of the steel plate 27. Then, the pneumatic system is started, such that the piston 13 is pushed downwards to extrude the heat sink paste within the depot 12. The time for supplying the pneumatic pressure is controlled, such that the heat sink paste is sufficient for filling up the screen printing area of the steel plate 27. Then, the scraping surface 17 is moved laterally against the surface of the steel plate 27 by the robot arm 29, such that the redundant heat sink paste can be scraped off and the heat sink paste surface can be smoothed by the scraping surface 17.

In summary, the injector with a coating header disclosed by the present invention provides an effect of quantifying the heat sink paste and uniformly coating the surface to be coated without the aid of the steel plate, and it also can be used to uniformly fill the screen printing area, scrape off redundant heat sink paste, and smooth the coated heat sink paste surface, in the case that the steel plate is used. Moreover, the present invention can be an integrated injector with a coating head, or an injector with a coating head installed in the body. The present invention is suitable for manual operation or mechanical operation.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An injector with a coating head, for uniformly coating a heat sink paste onto a surface to be coated, wherein a steel plate is electively covered around the surface to be coated, comprising:
a body, having a depot and an outlet, wherein the depot is used for accommodating the heat sink paste;
a piston, for being plugged through the depot, wherein a relative displacement occurs between the piston and the depot to extrude the heat sink paste through the outlet; and
a coating head, having a joint end and a discharge end, wherein the joint end is installed on the body for communicating with the outlet, and the discharge end receives the heat sink paste from the joint end and sends out the heat sink paste onto the surface to be coated, wherein an inner diameter of the discharge end is equal to a length of one side of the surface to be coated.

2. The injector with a coating head as claimed in claim 1, wherein the injector further comprises an elastic element, which provides a force for pressing the discharge end against the steel plate surface.

3. The injector with a coating head as claimed in claim 1, wherein a scraping surface is provided at the opening of the discharge end, and the scraping surface is used to scrape off the heat sink paste on the steel plate surface, and to smooth the surface of the heat sink paste surface coated on the surface to be coated.

4. The injector with a coating head as claimed in claim 1, wherein an accommodation space is provided within the discharge end, and a cross-sectional area of the accommodation space is equal to a surface area of the surface to be coated.

5. The injector with a coating head as claimed in claim 1, wherein the coating head further comprises a vent hole.

6. An injector with a coating head, for uniformly coating a heat sink paste onto a surface to be coated, wherein a steel plate is selectively covered around the surface to be coated, comprising:
a body, having a depot and a coating head, wherein the depot is used to accommodate the heat sink paste, and an inner diameter of the coating head is equal to a length of one side of the surface to be coated; and
a piston, for being plugged through the depot, wherein a relative replacement occurs between the piston and the depot to extrude the heat sink paste through the coating head to send out the heat sink paste onto the surface to be coated.

7. The injector with a coating head as claimed in claim 6, wherein the injector further comprises an elastic element, which is used to provide a force for pressing the coating head against the steel plate surface.

8. The injector with a coating head as claimed in claim 6, wherein a scraping surface is provided at the opening of the coating head, and the scraping surface is used to scrap off the heat sink paste on the steel plate surface, and to smooth the surface of the heat sink paste coated on the surface to be coated.

9. The injector with a coating head as claimed in claim 6, wherein an accommodation space is provided within the coating head, and a sectional area of the accommodation space is equal to a surface area of the surface to be coated.
